(19) United States
(12) Patent Application Publication
(10) Pub. No.: US 2024/0025333 A1
(43) Pub. Date: Jan. 25, 2024

(54) VEHICLE LAMP BODY APPARATUS

(71) Applicant: Honda Motor Co., Ltd., Tokyo (JP)

(72) Inventor: Yoshiro Tanaka, Wako-shi (JP)

(21) Appl. No.: 18/221,808

(22) Filed: Jul. 13, 2023

(30) Foreign Application Priority Data
Jul. 21, 2022 (JP) 2022-116025

(51) Int. Cl. B60Q 1/00; F21S 41/40

(52) U.S. Cl. CPC B60Q 1/0023; F21S 41/40; B60Q 1/04

(57) ABSTRACT

A vehicle lamp body apparatus including a light source, a wall portion disposed closer to an outer surface side of a vehicle than the light source, a radar unit mounted on the outer surface side of the vehicle of the wall portion, and a cover covering a surface of the radar unit so that an electromagnetic wave irradiated from the radar unit passes through. A first optical path is provided in an area other than a mounted area of the radar unit in the wall portion so that a light emitted from the light source passes through, and a second optical path is provided in the cover so that a light passing through the first optical path passes through.

### CROSS-REFERENCE TO RELATED APPLICATION

This application is based upon and claims the benefit of priority from Japanese Patent Application No. 2022-116025 filed on Jul. 21, 2022, the content of which is incorporated herein by reference.

### BACKGROUND OF THE INVENTION

### Field of the Invention

This invention relates to a vehicle lamp body apparatus.

### Description of the Related Art

There is a known apparatus in which a radar is placed in the vicinity of a headlight of a vehicle. Such an apparatus is described, for example, in Japanese Unexamined Patent Publication No. 2021-091303 (JP2021-091303A). In the apparatus described in JP2021-091303A, the radar is positioned on a side of the headlight in the vehicle width direction, and a radar cover facing the radar surface is formed on the same surface as an outer lens on a surface of the headlight.

However, in the apparatus described on JP2021-091303A, the radar cover greatly hinders an emission of light from the headlamps to an outside of the vehicle.

### SUMMARY OF THE INVENTION

An aspect of the present invention is a vehicle lamp body apparatus including a light source, a wall portion disposed closer to an outer surface side of a vehicle than the light source, a radar unit mounted on the outer surface side of the vehicle of the wall portion, and a cover covering a surface of the radar unit so that an electromagnetic wave irradiated from the radar unit passes through. A first optical path is provided in an area other than a mounted area of the radar unit in the wall portion so that a light emitted from the light source passes through, and a second optical path is provided in the cover so that a light passing through the first optical path passes through.

### BRIEF DESCRIPTION OF THE DRAWINGS

The objects, features, and advantages of the present invention will become clearer from the following description of embodiments in relation to the attached drawings, in which:

FIG. 1 is a diagram illustrating a schematic configuration of a front part of a vehicle provided with a vehicle lamp body apparatus according to an embodiment of the invention;

FIG. 2 is a diagram illustrating a reference example of FIG. 1;

FIG. 3 is a front view illustrating a configuration of main component of the vehicle lamp body apparatus according to the embodiment of the invention; and

FIG. 4 is a cross-sectional view taken along line IV-IV of FIG. 3.

### DETAILED DESCRIPTION OF THE INVENTION

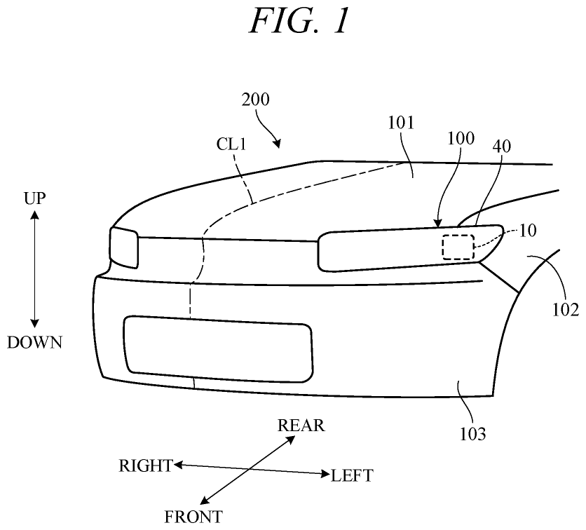

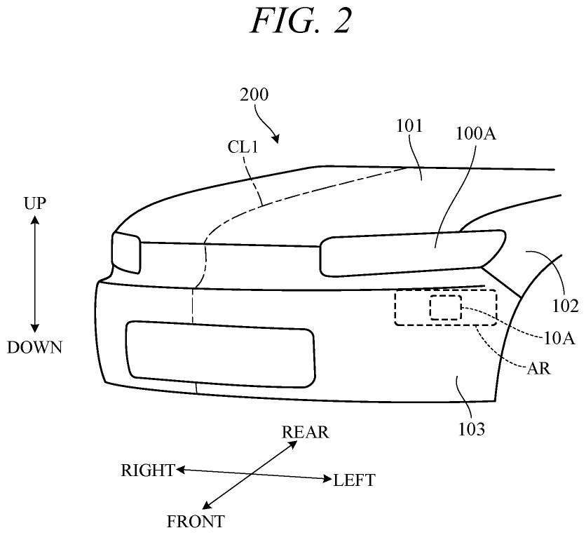

Hereinafter, an embodiment of the present invention is explained with reference to FIGS. 1 to 4. A vehicle lamp body apparatus according to an embodiment of the present invention includes a lamp body such as a headlight. FIG. 1 is a diagram illustrating a schematic configuration of a front part of a vehicle provided with a vehicle lamp body apparatus 100 according to the present embodiment (a diagram of a vehicle 200, when viewed from an obliquely front side), and FIG. 2 is a diagram illustrating a reference example of FIG. 1. Hereinafter, for the sake of convenience, a front-rear direction, a left-right direction, and an up-down direction are defined as illustrated in the drawing, and the configuration of each unit will be described in accordance with such definitions.

The vehicle 200 is configured to be bilaterally symmetrical with an axis CL1 extending in the front-rear direction as the center, in its appearance shape. Hence, in FIG. 1, although the vehicle lamp body apparatus 100 on the left side of a front end part of the vehicle 200 is illustrated, the vehicle lamp body apparatus 100 is similarly provided on the right side of the front end part of the vehicle 200. Hereinafter, the configuration of the vehicle lamp body apparatus 100 on the left side will be described. As illustrated in FIG. 1, the vehicle lamp body apparatus 100 is disposed on a front side of a hood 101 and a fender 102, and is disposed above a bumper 103.

The vehicle lamp body apparatus 100 of FIG. 1 includes not only a lamp body but also a radar unit 10 (for example, a millimeter wave radar). The radar unit 10 is a distance detector that irradiates electromagnetic waves and detects reflected waves to detect other vehicles, obstacles, and the like in the surroundings of the vehicle 200, and includes a generator that generates electromagnetic waves, a transmitter that transmits electromagnetic waves, a receiver that receives reflected waves reflected by an object, and the like. The radar unit 10 will simply be referred to as a radar, in some cases.

As illustrated in FIG. 2, in the reference example, a radar 10A is provided separately from a vehicle lamp body apparatus 100A. For example, the radar 10A is disposed inside the bumper 103 made of resin. An area AR in FIG. 2 is an irradiation range of the electromagnetic waves irradiated from the radar 10A (a range through which the electromagnetic waves are transmitted). In order for the radar 10A to accurately detect the distance to an object, the electromagnetic waves have to be uniformly transmitted over the area AR. For this reason, the bumper 103 in the area AR is preferably formed smoothly without a corner portion and with constant thickness. In addition, no metallic coating is applied onto the area AR, and no metal component is disposed in the area AR, which is desirable in order to ensure the accuracy of the radar 10A.

In a case where the radar 10A is disposed inside the bumper 103 in this manner, it is necessary to smoothly form the surface of the bumper 103. Thus, there is no mark for the position of the radar 10A in its appearance, and it is difficult to recognize the attachment position (mounted position) of the radar 10A from the outside. Therefore, even if there is damage such as a scratch or a dent on the surface of the area AR of the bumper 103, a driver may not recognize that such damage adversely affects the detection accuracy of the radar 10A and leave the surface in a damaged state. Alternatively, the damage to the bumper 103 may be inappropriately repaired with no consideration for degradation in the detection accuracy of the radar 10A. Furthermore, there is a possibility that a sticker or the like that degrades the detection accuracy of the radar 10A is attached to the surface of the area AR of the bumper 103.

In this regard, in the present embodiment, the radar 10 is included in the vehicle lamp body apparatus 100, and the radar 10 is not disposed inside the bumper 103. Therefore, the bumper 103 is not restricted by the installation of the radar 10, and the degree of freedom for the shape of the bumper 103 can be increased. In addition, since the vehicle lamp body apparatus 100 is disposed in a position less likely to be damaged than that in the bumper 103, it is easy to maintain the detection accuracy of the radar 10. Furthermore, it is also easy to recognize the attachment position of the radar 10 from the outside.

However, a lamp body (light source) is disposed in the vehicle lamp body apparatus 100. Hence, in a case where the vehicle lamp body apparatus 100 is configured to include the radar 10, there is a possibility that the emission of light from the light source to the outside of the vehicle is largely hindered by the radar 10. In consideration of such a possibility, in the present embodiment, the vehicle lamp body apparatus 100 is configured as follows.

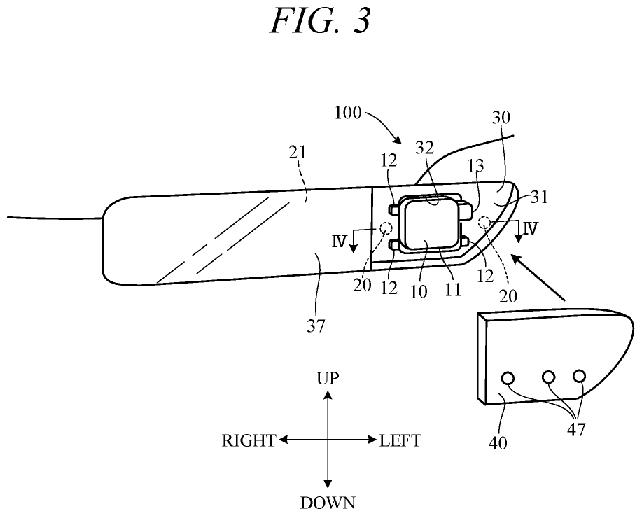

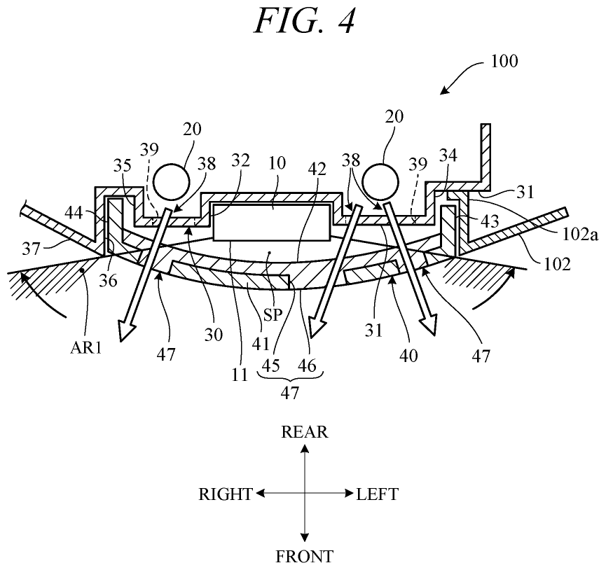

FIG. 3 is a front view illustrating a configuration of main components of the vehicle lamp body apparatus 100 according to the present embodiment, and FIG. 4 is a cross-sectional view taken along line IV-IV of FIG. 3. FIG. 3 illustrates a state in which a part (a cover 40) of the vehicle lamp body apparatus 100 is disassembled. As illustrated in FIGS. 3 and 4, the vehicle lamp body apparatus 100 includes a light source the radar 10 disposed on a front side of the light source 20, an outer lens 30 disposed between the light source 20 and the radar 10, and a cover 40 disposed on a front side of the radar 10.

The outer lens 30 includes a wall portion 31 extending in the up-down direction and the left-right direction, and a depressed portion 32 having a substantially rectangular shape in a front view is formed in the wall portion 31. A housing 11 of the radar 10 having a substantially box shape with predetermined thickness is accommodated in the depressed portion 32. As illustrated in FIG. 3, the housing 11 of the radar 10 is provided with a plurality of stays 12, which protrude in the left-right direction, so that the radar 10 is fixed onto the outer lens 30 by bolts (not illustrated) that respectively penetrate into the stays 12. Furthermore, a connector 13 protrudes from the housing 11 of the radar 10 in the left-right direction (for example, to the left), and cables of a power line and a signal line are connected with the radar 10 through the connector 13.

As illustrated in FIG. 4, the light sources 20 are respectively provided on the outer sides in the left-right direction of the depressed portion 32. That is, the light sources 20 are a pair of left and right light sources respectively disposed on the outer sides in the left-right direction of the radar 10, and each light source 20 includes an LED, a light bulb, or the like that generates light by electric power supplied from a battery.

Recessed portions 34 and 35, which are recessed rearward, are respectively provided in a left end portion and a right end portion of the wall portion 31. A right end surface of the recessed portion 35 extends forward, and forms a boundary wall 36. A right end surface of the fender 102 extends rearward toward the recessed portion 34, and forms a boundary wall 102a. A radar chamber SP for accommodating the radar 10 is formed between the left and right boundary walls 36 and 102a. The outer lens 30 is made of a resin material having a light-transmitting property. The outer lens 30 integrally includes a lens portion 37, which extends rightward from a front end portion of the boundary wall 36. The lens portion 37 is formed in a convex curved surface shape toward the front side (see FIG. 1), and another light source 21 (FIG. 3) is disposed on a rear side of the lens portion 37. The lens portion 37 may be provided separately from the outer lens 30.

Since the outer lens 30 is made of a resin material having the light-transmitting property, optical paths 38 (first optical path) through which light from the light source 20 passes are respectively formed on both left and right sides of the depressed portion 32 of the outer lens 30, as indicated by arrows in FIG. 4. The outer lens 30 can be made of a resin material having no light-transmitting property (having a light-shielding property). In this case, as illustrated in FIG. 4, openings 39 (dotted lines) facing the light source 20 and penetrating into the wall portion 31 in the front-rear direction are respectively provided on the outer sides in the left-right direction of the depressed portion 32, in the wall portion 31 of the outer lens 30. In other words, the openings 39 are respectively provided to be shifted in position in the left-right direction from the radar 10, so that the light traveling forward from the light source 20 is not shielded by the radar 10, and the optical paths 38 are formed by the openings 39.

The cover 40 includes a front surface portion 41 made of a resin having no light-transmitting property, and a rear surface portion 42 made of a resin having a light-transmitting property, and the entirety of the cover 40 is formed by integral molding. The rear surface portion 42 is disposed on a rear side of the front surface portion 41. The front surface portion 41 extends in the front-rear and left-right directions with the radar 10 as the center, on a front side of the radar 10. Protrusion portions 43 and 44 extending rearward are respectively provided in both left and right end portions of the front surface portion 41. The protrusion portions 43 and 44 are respectively fitted into the left and right recessed portions 34 and 35 of the outer lens 30, while being guided by the boundary walls 36 and 102a. Accordingly, the cover 40 is attached onto the outer lens 30. An illustration is omitted, but protrusion portions extending rearward are similarly provided in an upper end portion and a lower end portion of the front surface portion 41, and in addition, recessed portions are provided in the outer lens 30 to respectively correspond to the protrusion portions.

The front surface portion 41 is formed in a smooth curved surface shape with a predetermined curvature in the left-right direction. A plurality of through holes 45 are provided in the front surface portion 41 so as to correspond to the positions of the light sources 20. The rear surface portion 42 is provided along a rear surface of the front surface portion 41 between the protrusion portions 43 and 44. The through hole 45 is filled with the rear surface portion 42, and a filling portion 46 is formed. Accordingly, the cover 40 extends in the up-down direction and left-right direction with constant thickness as a whole from the rear surface of the rear surface portion 42 to a front surface of the front surface portion 41. In this situation, the through hole 45 of the front surface portion 41 and the filling portion 46, which is filled in the through hole 45, form an optical path (second optical path) 47 through which light is transmissible. In FIG. 4, for the sake of convenience, the cover 40 is illustrated such that a front part of the radar 10 is located in a foremost position. However, in practice, as illustrated in FIG. 1, the cover 40 is formed in a smooth curved surface shape toward a rear side and toward outer sides in the left-right direction.

The cover 40 (the front surface portion 41 and the rear surface portion 42) is made of a resin material through which the electromagnetic waves irradiated from the radar 10 are transmissible. In FIG. 4, an irradiation area AR1 of the electromagnetic waves irradiated from the radar 10 is indicated by hatching. Such an irradiation area AR1 is an area having a predetermined angle (for example, 160 degrees to 170 degrees) in a horizontal direction with the radar 10 as the center. The cover 40 is formed in the left-right direction to include the entirety of the irradiation area AR1. Accordingly, the electromagnetic waves that have been irradiated from the radar 10 uniformly transmit through the cover 40 over the entirety of the irradiation area AR1. Therefore, the distance to an object can be accurately detected by use of the radar 10.

In addition, since the through hole 45 as a transmission portion is opened in the cover 40 (the front surface portion 41), the light emitted from the light source 20 is emitted forward through the optical path 47 (the through hole 45 and the filling portion 46) as indicated by an arrow in FIG. 4. For example, the light is emitted forward through the through hole (a through hole at the center in the left-right direction) 45, which is provided on a front side of the radar 10. Accordingly, the light source 20 can be disposed in the vicinity of the radar 10, and the light that has been emitted from the light source 20 can be efficiently emitted to the outside along the optical path 47, which is provided in the cover 40 including the front surface portion 41 with no light-transmitting property. As a result, it becomes possible to save the installation space of the entire vehicle lamp body apparatus 100 including the light source 20 and the radar 10.

According to the present embodiment, the following operations and effects are achievable.

(1) The vehicle lamp body apparatus 100 includes: the light source 20; the wall portion 31, which is disposed on an outer surface side of the vehicle 200 relative to the light source 20; the radar 10, which is attached onto the wall portion 31 (the depressed portion 32) on the outer surface side of the vehicle 200 relative to the wall portion 31; and the cover 40, which covers the surface of the radar 10, and through which an electromagnetic wave (electric wave) irradiated from the radar 10 passes (FIGS. 3 and 4). The wall portion 31 is configured by a material having a light-transmitting property. In the wall portion 31, the optical path 38, through which the light that has been emitted from the light source 20 passes, is formed in an area other than the attachment area of the radar 10 in the wall portion 31 (FIG. 4). In the cover 40, the optical path 47, through which the light that has passed through the optical path 38 passes, is formed (FIG. 4). Accordingly, the light from the light source 20 is emitted forward through the cover 40 on the front side of the radar 10, and the light from the light source 20 can be efficiently emitted to the outside.

(2) The wall portion 31 can be mad of a material having a light-shielding property. In this case, the optical path 38 of the wall portion 31 is configured by the opening 39, which is provided in the wall portion 31 (FIG. 4). Accordingly, the wall portion 31 can be made of various materials each having high strength.

(3) The optical path 47 of the cover 40 is provided in an irradiation range (the area AR) of the electromagnetic wave irradiated from the radar 10 (FIG. 4). Accordingly, the light source 20 can be disposed in the vicinity of the radar 10, and the entire apparatus can be configured in a small size.

(4) The optical path 47 of the cover 40 is provided in a position facing the radar 10 (FIG. 4). Accordingly, the position of the radar 10 can be easily recognized from the outside.

(5) The cover 40 extends to face the optical path 38 of the wall portion 31 and the radar 10 (FIG. 4). Accordingly, it is not necessary to provide a member for emitting the light from the light source 20 separately from the cover 40, so that the number of components can be saved.

(6) The cover 40 is formed by integrally molding the front surface portion 41 made of a material having a light-shielding property, and a rear surface portion 42 made of a material having a light-transmitting property (FIG. 4). The optical path 47 of the cover 40 includes the through hole 45, which is formed in the front surface portion 41, and the filling portion 46, which is a part of the rear surface portion 42, and which fills the through hole 45 (FIG. 4). Accordingly, the cover 40, in which the through hole 45 is opened, can be formed to have constant plate thickness as a whole, so that the detection accuracy of the radar 10 can be enhanced.

The above embodiment can be varied into various forms. Some variations will be described below. Although in the above embodiment, the light source 20 is disposed on both left and right sides of the radar 10, the disposed position of a light source is not limited to the above configuration. For example, the light source 20 may be disposed on either a left or right side of the radar 10. In the above embodiment, the depressed portion 32 is provided in the wall portion 31 of the outer lens 30 and the radar 10 is placed in the depressed portion 32. However, any configuration of a wall portion can be used, as long as the wall portion is disposed closer to the outer surface side of the vehicle than the light source so that a radar unit is mounted thereon.

In the above embodiment, a portion of the plurality of optical paths 47 (second optical path) of the cover 40 is provided facing the radar 10, and the cover 40 is extended so as to face the optical path 38 (first optical path) formed in the wall portion 31 and the radar 10. However, any configuration of a cover covering the surface of the radar unit may be used, as long as the cover has the function of serving as both a transmitting surface through which the electromagnetic wave irradiated from the radar unit passes and a transmitting surface through which a light from the light source 20 passes. In the above embodiment, the cover 40 is configured by integrally molding the front surface portion 41 formed by a material having a light-shielding property (first material) and the rear surface portion 42 formed by a material having a light transmitting property (second material). However, a cover is not limited to those described above.

The above embodiment describes an example of a vehicle lamp body apparatus 100 provided at the front end of the vehicle 200, but a vehicle lamp body apparatus of the present invention can be provided in various positions, such as at a rear end or side end of the vehicle.

The above embodiment can be combined as desired with one or more of the above modifications. The modifications can also be combined with one another.

According to the present invention, in a vehicle lamp body apparatus including a radar unit, it is possible to efficiently emit light from a light source to the outside.

Above, while the present invention has been described with reference to the preferred embodiments thereof, it will be understood, by those skilled in the art, that various changes and modifications may be made thereto without departing from the scope of the appended claims.

What is claimed is:

1. A vehicle lamp body apparatus, comprising:
a light source;
a wall portion disposed closer to an outer surface side of a vehicle than the light source;
a radar unit mounted on the outer surface side of the vehicle of the wall portion; and
a cover covering a surface of the radar unit so that an electromagnetic wave irradiated from the radar unit passes through, wherein
a first optical path is provided in an area other than a mounted area of the radar unit in the wall portion so that a light emitted from the light source passes through, and
a second optical path is provided in the cover so that a light passing through the first optical path passes through.

2. The vehicle lamp body apparatus according to claim 1, wherein
the wall portion is formed by a material having a light-shielding property, and
the first optical path is configured by an opening provided in the wall portion.

3. The vehicle lamp body apparatus according to claim 1, wherein
the second optical path is provided inside an irradiation range of the electromagnetic wave irradiated from the radar unit.

4. The vehicle lamp body apparatus according to claim 1, wherein
the second optical path is provided at a position facing the radar unit.

5. The vehicle lamp body apparatus according to claim 1, wherein
the cover is extended so as to face the first optical path and the radar unit.

6. The vehicle lamp body apparatus according to claim 5, wherein
the cover is formed by integrally molding a first material having a light-shielding property and a second material having a light transmitting property, and
the second optical path is configured by a through hole formed in the first material and the second material filled in the through hole.

7. The vehicle lamp body apparatus according to claim 1, wherein
the wall portion includes a depressed portion,
the radar unit is disposed in the depressed portion, and
the light source is disposed on a side of the depressed portion.

8. The vehicle lamp body apparatus according to claim 1, wherein
the radar unit is disposed on a front surface of the vehicle, and
the light source is disposed on both left and right sides or either a left or right side of the radar unit.
